(19) United States
(12) Patent Application Publication
(10) Pub. No.: US 2026/0261126 A1
(43) Pub. Date: Sep. 3, 2026

(54) ARTIFICIAL INTELLIGENCE DEVICE AND OPERATING METHOD THEREOF

(71) Applicant: LG ELECTRONICS INC., Seoul (KR)

(72) Inventors: Jaehong KIM, Seoul (KR); Hongkyu KIM, Seoul (KR); Jihack LEE, Seoul (KR); Hyejeong JEON, Seoul (KR)

(73) Assignee: LG ELECTRONICS INC., Seoul (KR)

(21) Appl. No.: 19/552,592

(22) Filed: Feb. 27, 2026

(30) Foreign Application Priority Data
Feb. 28, 2025 (WO) PCT/KR2025/002832

(51) Int. Cl. H02J 3/32; G06N 3/0442; H02J 3/00

(52) U.S. Cl. CPC H02J 3/32; G06N 3/0442; H02J 3/003

(57) ABSTRACT

The artificial intelligence device of the present disclosure includes: a memory configured to store a learning model that is learned through a deep learning or machine learning algorithm and predicts an amount of energy corresponding to a component included in a system; and a processor, wherein the processor, by using the learning model, obtains a result predicting an amount of energy corresponding to the component included in the system for a certain period of time, based on data related to the component included in the system, determines, based on the result predicting the amount of energy, a schedule for controlling the component included in the system to minimize a charge based on the amount of energy supplied from a power system for the certain period of time, and controls the component included in the system according to the determined schedule.

### CROSS-REFERENCE TO RELATED APPLICATIONS

Pursuant to 35 U.S.C. § 119, this application claims the benefit of earlier filing date and right of priority to International Application No. PCT/KR2025/002832, filed on Feb. 28, 2025, the contents of which is hereby incorporated by reference herein in its entirety.

### BACKGROUND

### Field of the Invention

This disclosure relates to an artificial intelligence device and an operating method thereof, and more particularly, to an artificial intelligence device for controlling charging and discharging of an energy storage system (ESS) and an operating method thereof.

### Discussion of the Related Art

Artificial intelligence (AI) is a field of computer science and information technology that researches methods enabling computers to perform tasks such as thinking, learning, and self-improvement that human intelligence can accomplish, and signifies enabling computers to mimic human intelligent behaviour.

Furthermore, AI does not exist in isolation, but is directly and indirectly connected to other fields of computer science. In particular, there are active attempts today to incorporate AI elements into various fields of information technology, and utilize them to solve problems in those fields.

Meanwhile, electronic devices used in the home are becoming increasingly diverse for user convenience, and various automation systems are being developed to enhance productivity in various industries. However, as technology advances, power consumption is increasing not only in households but also across industry as a whole, and the burden of costs associated with the increasing power consumption is also growing.

Demand Response Service (DRS) for power is a service that adjusts users' power consumption according to fluctuations in power demand in a power system. This plays a crucial role in maintaining power supply stability and reducing costs, especially during times of power shortages or peak demand.

Demand response service may include detailed services such as a demand management service, an incentive-based service, and a real-time response service. The demand management service, when power supply is insufficient or the power system is overloaded, allows a power company to request customers to reduce their power consumption or postpone their use for a certain period of time. The incentive-based service provides financial compensation to consumers, when they reduce their power consumption during peak demand times or shift their consumption to lower demand times. The real-time response services sends real-time signals to consumers based on power system conditions or market price fluctuations, thereby accomplishing immediate power consumption adjustments.

To address the issues posed by increasing power consumption, active research is being conducted on systems that reduce power consumption costs while operate in line with user requirements

### SUMMARY

The disclosure has been made in view of the above problems, and may provide an artificial intelligence device capable of determining a schedule for the operation of component included in a system by predicting the power usage of the component included in the system, and the operating method thereof.

The disclosure may further provide an artificial intelligence device capable of determining a schedule for the operation of component included in a system by considering the charges for power usage, and the operating method thereof.

The disclosure may further provide an artificial intelligence device capable of determining a schedule for the operation of component included in a system by considering requests from customers or power providers, and the operating method thereof.

In accordance with an aspect of the present invention, an artificial intelligence device includes: a memory configured to store a learning model that is learned through a deep learning or machine learning algorithm and predicts an amount of energy corresponding to a component included in a system; and a processor, wherein the processor, by using the learning model, obtains a result predicting an amount of energy corresponding to the component included in the system for a certain period of time, based on data related to the component included in the system, determines, based on the result predicting the amount of energy, a schedule for controlling the component included in the system to minimize a charge based on the amount of energy supplied from a power system for the certain period of time, and controls the component included in the system according to the determined schedule.

In accordance with another aspect of the present invention, a method of operating an artificial intelligence device includes: an amount of energy prediction operation for obtaining, by using a learning model that is learned through a deep learning or machine learning algorithm and predicts an amount of energy corresponding to a component included in a system, a result predicting an amount of energy corresponding to the component included in the system for a certain period of time, based on data related to the component included in the system; a schedule determination operation for determining, based on the result predicting the amount of energy, a schedule for controlling the component included in the system to minimize a charge based on the amount of energy supplied from a power system for the certain period of time; and a control operation for controlling the component included in the system according to the determined schedule.

### BRIEF DESCRIPTION OF THE DRAWINGS

The above and other objects, features and advantages of the present invention will be more apparent from the following detailed description in conjunction with the accompanying drawings, in which:

FIG. 1 is a diagram illustrating a system according to an embodiment of the present disclosure;

FIG. 2 is a diagram illustrating component included in a system according to an embodiment of the present disclosure;

FIG. 5 is a diagram for explaining a power used and/or produced in a system according to an embodiment of the present disclosure;

FIG. 6 is a flowchart illustrating an operation method of an AI device according to an embodiment of the present disclosure;

FIGS. 7 to 10 are diagrams for explaining an operation of an AI device according to an embodiment of the present disclosure; and

FIG. 11 is a flowchart for explaining an operation method of an AI device according to an embodiment of the present disclosure.

### DETAILED DESCRIPTION

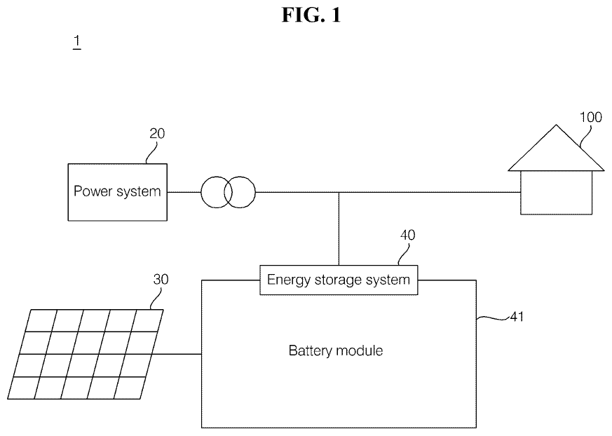

FIG. 1 is a diagram illustrating a system according to an embodiment of the present disclosure.

Referring to FIG. 1, a system 1 may include an artificial intelligence device 100, a power system 20, a power generation module 30, and/or an energy storage system (ESS) 40.

An artificial intelligence device 100 may communicate with component included in the system 1. For example, the artificial intelligence device 100 may receive data from component included in the system 1.

The artificial intelligence device 100 may control component included in the system 1. For example, the artificial intelligence device 100 may transmit commands to control operation of component included in the system 1.

In the present disclosure, the artificial intelligence device 100 is described as being deployed in a building corresponding to a user, but is not limited thereto.

A power system 20 may include power generation facilities, transmission lines, etc. that produce power.

The power generation module 30 may generate electrical energy. For example, when utilizing solar power, the power generation module 30 may be configured as a solar cell array. The solar cell array may be provided by coupling multiple solar cell modules. The solar cell module may have multiple solar cells connected in series or parallel. At this time, the power generation module 30 may convert solar energy into electrical energy and generate certain voltage and current. In the present disclosure, it is illustrated as an example that the power generation module 30 utilizes solar power generation, but is not limited thereto. For example, the power generation module 30 may include various types of generators, such as wind power, tidal power, hydroelectric power, and geothermal power.

The energy storage system 40 may store power supplied from the power system 20 and/or the power generation module 30. The energy storage system 40 may include a battery module 41 that stores power. The battery module 41 may include at least one battery. For example, the battery may include a lithium-ion battery LiB, a lead-acid battery, a sodium-sulfur battery NaS, a redox flow battery RFB, a supercapacitor, etc. The battery may be composed of a plurality of cells.

The energy storage system 40 may include a power conversion device that converts power. The power conversion device may include an inverter and/or a converter. For example, the converter may convert power output from the power generation module 30 into direct current corresponding to the energy storage system 40. For example, the inverter may convert power stored in the battery module 41 into alternating current.

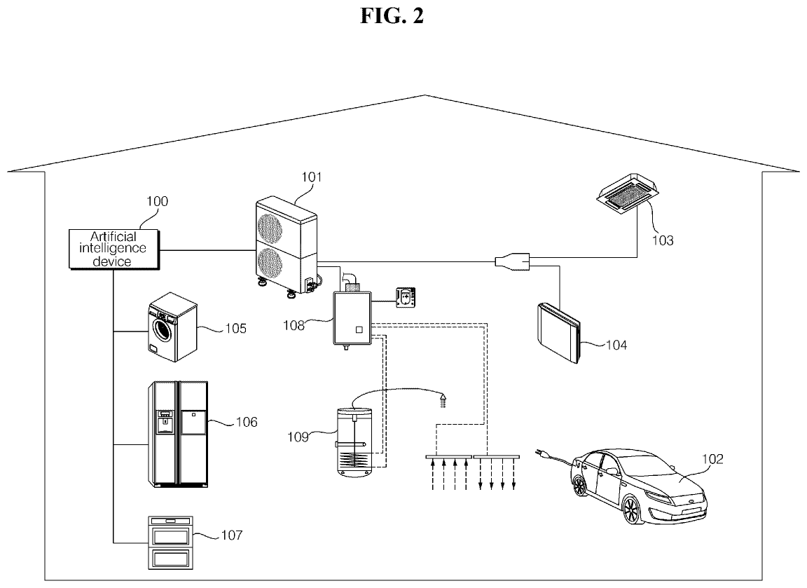

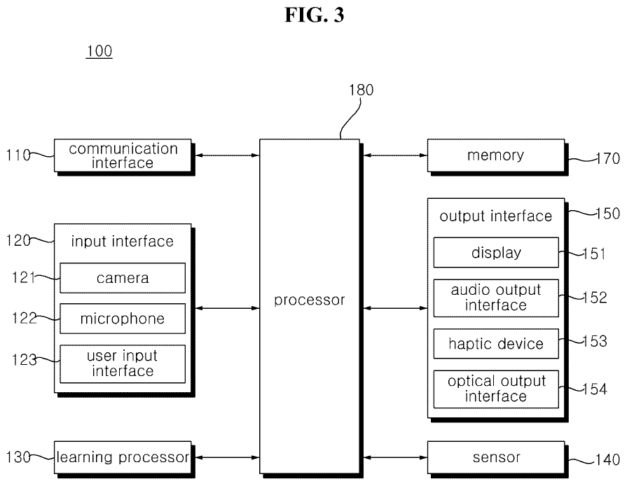

FIG. 2 is a diagram illustrating component included in a system, according to an embodiment of the present disclosure.

Referring to FIG. 2, the system 1 may include a component (hereinafter, a power-using device) that uses power. For example, the system 1 may include an outdoor unit 101, a vehicle charging device 102, an indoor unit 103, 104, a washing machine 105, a refrigerator 106, 107, a heating device 108, a water heater 109, and the like. According to an embodiment, the outdoor unit 101, the indoor unit 103, 104, the heating device 108, the water heater 109, etc., may be included in a heat pump.

The artificial intelligence device 100 may communicate with a power-using device. For example, the artificial intelligence device 100 may be connected to multiple power-using devices through a certain network, or may be individually connected through different types of network.

The artificial intelligence device 100 may control a power-using device.

For example, the artificial intelligence device 100 may adjust the operating frequency of the compressor included in the outdoor unit 101. For example, the artificial intelligence device 100 may adjust a set value (hereinafter, indoor set temperature) for the indoor temperature corresponding to the indoor unit 103, 104. For example, the artificial intelligence device 100 may adjust a set value (hereinafter, hot water set temperature) for the temperature of water stored in a hot water tank included in the water heater 109.

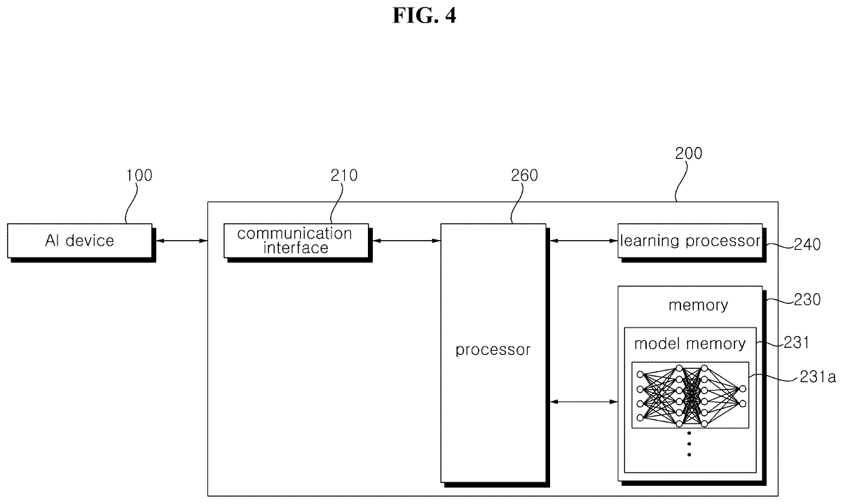

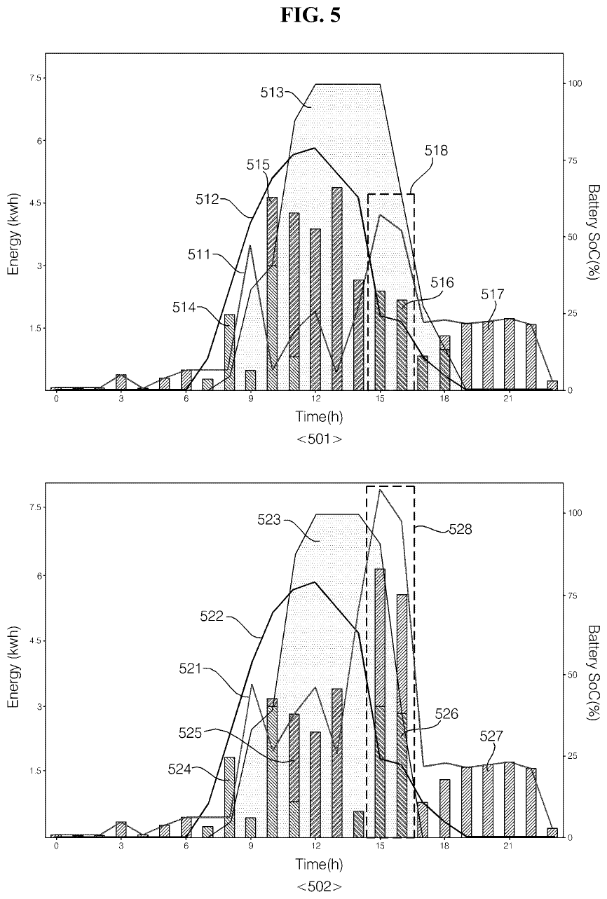

FIG. 5 is a diagram for explaining a power used and/or produced in a system, according to an embodiment of the present disclosure.

The graphs shown in FIG. 5 may indicate, by time zone, the amount of power 511, 521 used in the system 1, the amount of power 512, 522 produced in the system 1, the state of charge 513, 523 of the battery module 410, the amount of power 514, 524 charged to the battery module 410, the amount of surplus power 515, 525 produced in the system 1, the amount of power 516, 526 supplied from the energy storage system 40 to a power-using device, and the amount of power 517, 527 supplied from the power system 20 to a power-using device.

Referring to reference numeral 501, during a first peak period 518 when the amount of power 511 used by the power-using device is at its maximum, power may not be supplied from the power system 20 to the power-using device. That is, during the first peak period 518, the power-using device may be operated according to user demand solely with the power supplied from the energy storage system 40.

Referring to reference numeral 502, during a second peak period 528 when the amount of power 521 used by the power-using device is at its maximum, power may be supplied to the power-using device from both the power system 20 and the energy storage system 40. That is, during the second peak period 528, the power-using device cannot be operated according to user demand solely with the power supplied from the energy storage system 40. At this time, the power-using device may receive additional power from the power system 20 to operate according to user demand.

Meanwhile, there may exist the amount of surplus power 525 produced by the system 1 prior to the second peak period 528. In this case, if the amount of power 524 stored in the energy storage system 40 and/or the amount of surplus power 525 produced by the system 1 prior to the second peak period 528 is utilized to operate a power-using device in response to user demand, the power supplied to the power-using device from the power system 20 during the second peak period 528 may be reduced.

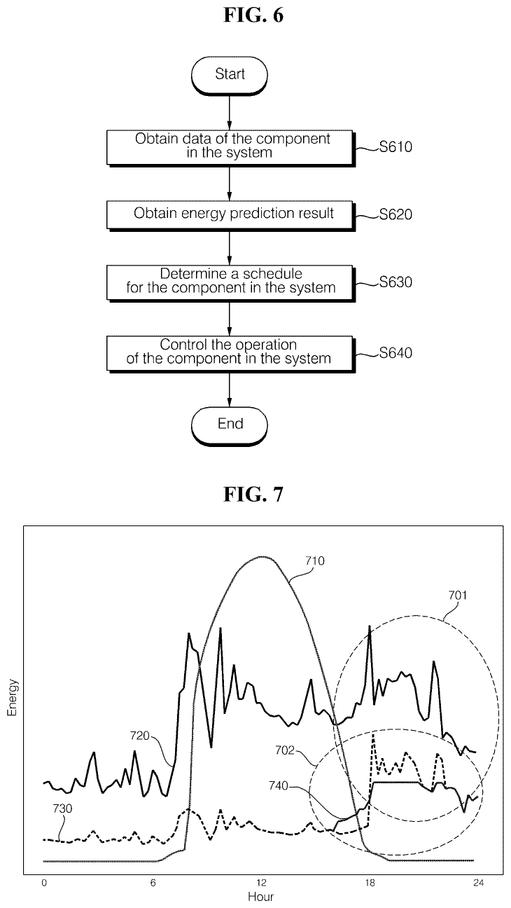

FIG. 6 is a flowchart illustrating an operating method of an artificial intelligence device, according to an embodiment of the present disclosure.

Referring to FIG. 6, the artificial intelligence device 100 may obtain data related to the component included in the system 1, at operation S610. For example, the artificial intelligence device 100 may obtain data such as the amount of power supplied from the power system 20, the amount of power produced by the power generation module 30, the amount of power stored in the energy storage system 40, the amount of power supplied from the energy storage system 40, and data related to power-using device.

Here, data related to power-using device may vary depending on the type of power-using device. For example, if the power-using device is a heat pump, data related to the heat pump may include operation mode, indoor temperature, outdoor temperature, hot water set temperature, cooling set temperature, floor heating set temperature, temperature of water stored in the hot water tank, temperature of water supplied from the outside, temperature of water discharged from the hot water tank, temperature of water flowing in a heating circulation path, operating frequency of a compressor, temperature of refrigerant discharged from the compressor, pressure of refrigerant discharged from the compressor, temperature of refrigerant flowing into the compressor, pressure of refrigerant flowing into the compressor, and amount of power used by the heat pump.

The artificial intelligence device 100 may store data related to the component included in the system 1. For example, the artificial intelligence device 100 may store data related to the component included in the system 1 into the memory 170. For example, the artificial intelligence device 100 may transmit the obtained data to the server 200 so that the data related to the component included in the system 1 is stored in the memory 230 of the server 200. In the present disclosure, the storage of data related to the component included in the system 1 into the memory 170 of the artificial intelligence device 100 will be described as an example.

According to an embodiment, the artificial intelligence device 100 may verify whether data related to the component included in the system 1 has been stored for a preset period of time or longer. For example, the artificial intelligence device 100 may check whether data related to the component included in the system 1 has been stored for a preset period of time or longer (e.g., one week) after initial operation is started. At this time, if data related to component included in the system 1 has been stored for a preset period of time or longer, the artificial intelligence device 100 may perform the following operations.

At operation S620, the artificial intelligence device 100 may obtain a result (hereinafter, “energy prediction result”) predicting energy corresponding to component included in the system 1, by using a learning model (hereinafter, “energy prediction model”) that predicts the energy used or stored by the component included in the system 1. For example, the artificial intelligence device 100 may obtain an energy prediction result for 24 hours based on midnight. That is, the artificial intelligence device 100 may periodically obtain energy prediction results for a certain period.

In an embodiment, the memory 170 may store the energy prediction model. The processor 180 may learn the energy prediction model and store it into the memory 170. In another embodiment, the processor 180 may receive the energy prediction model learned by the artificial intelligence server 200 from the artificial intelligence server 200.

The artificial intelligence device 100 may use an energy prediction model to calculate the amount of energy expected to be produced by the power generation module 30, the amount of energy expected to be stored in the energy storage system 40, the amount of energy expected to be supplied from the energy storage system 40, and the amount of energy expected to be consumed by the power-using device.

Here, the energy prediction model may be an artificial neural network-based model trained using a deep learning algorithm or a machine learning algorithm. The energy prediction model may be a model that outputs energy prediction results from a certain point in time to a point in time after a preset time interval. The energy prediction results may include the trend in amount of energy from a certain point in time up to a point in time corresponding to a pre-set time interval.

According to an embodiment, the energy prediction model may be a transLSTM model. The transLSTM model may be a hybrid model combining a Transformer model and a Long Short-Term Memory (LSTM) model.

Input data input to the energy prediction model may include amount of energy information, weather information, and time information. The input data of the energy prediction model may include past amount of energy information, past weather information, and past time information. The time information may include information encoded according to a position encoding method based on a periodic function.

The input data may be sequence data or time series data. The input data may be referred to as sequence data or time series data. The input data may be a set of input unit data obtained at specific time intervals over a given period of time. The input data may include input unit data.

The amount of energy information may be the amount of energy at specific time intervals over a certain period of time in the past. The amount of energy may include at least one of power generation and consumption. The given period of time may be one week or two weeks, and the specific time interval may be one hour or one minute, but these are just examples.

Weather information (or meteorological information) may include at least one of wind speed, temperature, humidity, cloud cover, and precipitation for a specific time interval over a given period of time in the past.

Time information may include information indicating the time corresponding to amount of energy information and weather information.

The processor 180 may convert the input unit data including the amount of energy, weather information, and time information corresponding to the same point in time into an embedding unit vector. For example, if the time information is 10:00 AM one week prior to the present, the processor 180 may convert the input unit data including the amount of energy, weather information, and time information (10:00 AM) corresponding to that point in time into an embedding unit vector. The processor 180 may transmit multiple embedding unit vectors to the energy prediction model.

According to an embodiment, the artificial intelligence device 100 may calculate the amount of energy expected to be used by a specific device, by using an input value corresponding to a specific device among power-using devices.

For example, if a specific device is a heat pump, a hot water set temperature corresponding to a specific point in time may be preset, based on user input or usage pattern. At this time, the artificial intelligence device 100 may calculate the amount of energy expected to be used in the operation of the heat pump to raise the temperature of water stored in the hot water tank to the hot water set temperature at a specific point in time. The input value of the energy prediction model for calculating the amount of energy expected to be used by the heat pump may include at least one of day of the week, operation mode, outdoor temperature, hot water set temperature, temperature of water stored in the hot water tank, temperature of water supplied from outside, temperature of water discharged from the hot water tank, discharge temperature, and suction temperature. The output value of the energy prediction model may include the amount of energy expected to be used by the heat pump and the amount of temperature change in the water stored in the hot water tank.

At operation S630, the artificial intelligence device 100 may determine a schedule for the operation of the component included in the system 1, based on the energy prediction result. Here, the schedule may include a sequence of setting values for the operation of a certain component included in the system 1.

For example, if the certain component is the energy storage system 40, the artificial intelligence device 100 may schedule the operation of the energy storage system 40 to store or release energy for a certain period of time. At this time, the schedule may include a sequence of operations of the energy storage system 40 set for each period corresponding to a certain time.

The artificial intelligence device 100 may determine a schedule that minimizes a charge based on the amount of energy supplied from the power system 20. For example, the amount of energy supplied from the power system 20 may correspond to the amount of energy expected to be produced by the power generation module 30, the amount of energy expected to be stored or released by the energy storage system 40, and/or the amount of energy expected to be used by a power-using device.

At this time, the artificial intelligence device 100 may determine a schedule that minimizes a charge based on the amount of energy supplied from the power system 20, in consideration of the time-based charge for the use of electricity supplied from the power system 20.

According to an embodiment, the artificial intelligence device 100 may determine a schedule, based on an objective function for the charge based on the amount of energy supplied from the power system 20, as shown in Equation 1 below. At this time, the artificial intelligence device 100 may determine a schedule for the operation of the energy storage system 40 to store or release energy, in which the objective function is minimized. The following explanation is based on interval-based data corresponding to a certain time, i.e., 1 hour, but is not limited thereto.

$$min {\sum }_{t = 0}^{23} T o U ( t ) * ( {E}_{grid} ( t ) ) \qquad [ Equation 1 ]$$

$${E}_{grid} ( t ) = {E}_{bat} ( {A}_{ess} ( t ) ) - {E}_{pv} ( t ) + {E}_{usage} ( t )$$

Here, ToU indicates the time-based charge for the use of energy supplied from the power system 20. Egrid indicates the amount of energy supplied from the power system 20. Ebat indicates the amount of energy stored in the energy storage system 40. If the value of Ebat is greater than 0, energy may be stored in the energy storage system 40. If the value is less than 0, energy may be released from the energy storage system 40. Aess indicates a schedule for the operation of the energy storage system 40. Epv indicates the amount of energy produced by the power generation module 30. Eusage indicates the amount of energy used by a power-using device.

The artificial intelligence device 100 may determine a schedule for the energy storage system 40 to minimize an objective function for charges based on the amount of energy supplied from the power system 20.

According to an embodiment, the artificial intelligence device 100 may determine a schedule, based on the objective function for charges based on the amount of energy supplied from the power system 20 as shown in Equation 2 below. At this time, the artificial intelligence device 100 may determine a schedule for the operation of the energy storage system 40 to store or release energy, and a schedule for the operation of the power-using device, in which the objective function is minimized.

$$min {\sum }_{t = 0}^{23} T o U ( t ) * ( {E}_{grid} ( t ) ) \qquad [ Equation 2 ]$$

$${E}_{grid} ( t ) = {E}_{bat} ( {A}_{ess} ( t ) ) - {E}_{pv} ( t ) + {E}_{usage} ( t )$$

$${E}_{usage} ( t ) = {E}_{hvac} ( t , {A}_{mode} ( t ) , {A}_{set} ( t ) ) + {E}_{hpwh} ( t , {A}_{mode} ( t ) , {A}_{set} ( t ) ) + {E}_{evc} ( t , {A}_{mode} ( t ) ) + ⋯$$

Here, Evac indicates the amount of energy used by the air conditioner, Ehpwh indicates the amount of energy used by the heat pump, and Eevc indicates the amount of energy used by the vehicle charging device 102. Meanwhile, Amode indicates a schedule for controlling the mode set for each device, and Aset indicates a schedule for controlling a set value set for each device.

For example, the artificial intelligence device 100 may determine a schedule for the operation mode of the air conditioner, a schedule for the indoor set temperature, a schedule for the hot water set temperature, a schedule for the operating frequency of the compressor of heat pump, a schedule for the mode for charging the vehicle at the vehicle charging device 102, etc., in which the objective function for the charge based on the amount of energy supplied from the power system 20 is minimized.

According to an embodiment, the AI device 100 may determine a schedule that minimizes an objective function for a charge based on the amount of energy supplied from the power system 20, based on the constraints of Equation 3 below.

$${C}_{limited} ( t ) \geq {E}_{usage} ( t ) , m \leq t < n \qquad [ Equation 3 ]$$

Here, m and n indicate the start and end points of a specific period, and Climited indicates a value (hereinafter, “demand limit value”) that limits the amount of energy used by a power-using device in a specific period. The demand limit value may be a maximum amount of energy permitted for use by a power-using device in a specific period.

In determining a schedule that minimizes an objective function for a charge based on the amount of energy supplied from the power system 20, the AI device 100 may determine a schedule that limits the amount of energy used by a power-using device in a specific period to a demand limit value or less.

According to an embodiment, the artificial intelligence device 100 may determine a schedule for limiting the amount of energy used by a power-using device to a demand limit value or less in a specific period, based on the priorities of the power-using devices. In this case, if the priority of a first device is higher than that of a second device, the decrease in the amount of energy used by the first device in a specific period due to the schedule adjustment may be less than the decrease in the amount of energy used by the second device.

According to an embodiment, if the amount of energy used by a power-using device is preset to be limited to a demand limit value or less, the artificial intelligence device 100 may determine a schedule for limiting the amount of energy used by the power-using device to a demand limit value or less in a specific period. For example, the artificial intelligence device 100 may preset, through the user input interface 123, the amount of energy used by the power-using device to the demand limit value or less, in response to a user input agreeing to limit the amount of energy used by the power-using device to the demand limit value or less.

According to an embodiment, if the amount of energy used by a power-using device exceeds a demand limit value in a specific period, the AI device 100 may output a notification for the limitation of the amount of energy used by the power-using device in the specific period, through the output interface 150.

If the amount of energy used by the power-using device in a specific period exceeds the demand limit value, the AI device 100 may adjust the schedule for the operation of the power-using device, according to a user input received through the user input interface 123.

For example, the AI device 100 may change the mode, setting values, etc. of the power-using device in a specific period, according to a user input regarding the power-using device received through the user input interface 123.

For example, the AI device 100 may determine a schedule that limits the amount of energy used by the power-using device in the specific period to a demand limit value or less, according to a user input regarding automatic adjustment of the schedule received through the user input interface 123.

In an embodiment, the AI device 100 may recommend a schedule that adjusts the amount of energy used by a power-using device in a specific period to be a demand limit value or less. For example, if the amount of energy used by a power-using device in a specific period exceeds a demand limit value, the AI device 100 may determine a schedule that limits the amount of energy used by a power-using device in a specific period to be a demand limit value or less. In this case, the AI device 100 may, through the output interface 150, recommend a mode, a set value, etc. of a power-using device in a specific period, corresponding to a schedule that limits the amount of energy used by a power-using device in the specific period to be a demand limit value or less.

In an embodiment, the AI device 100 may transmit the energy prediction result and/or the schedule for the operation of the component included in the system 1 to a user's terminal.

At operation S640, the AI device 100 may control the operation of the component included in the system 1, based on the schedule for the operation of the component included in the system 1.

For example, the artificial intelligence device 100 may control the charging and discharging of the energy storage system 40, based on a schedule for the energy storage system 40 to minimize an objective function for charges based on the amount of energy supplied from the power system 20.

For example, the artificial intelligence device 100 may control the hot water set temperature, the operating frequency of the compressor of heat pump, etc., based on a schedule for the operation of the heat pump to minimize an objective function for charges based on the amount of energy supplied from the power system 20.

Meanwhile, at least some of the operations of the artificial intelligence device 100 may be performed on the server 200. For example, the server 200 may obtain data related to component included in the system 1, from component included in the system 1. For example, the server 200 may use an energy prediction model to calculate energy prediction results. For example, the server 200 may determine a schedule for the operation of component included in the system 1. For example, the server 200 may transmit data related to the component included in the system 1, energy prediction results, and/or schedules for the operation of the component included in the system 1 to the artificial intelligence device 100.

The graphs illustrated in FIG. 7 may indicate, by time zone, an expected amount of energy produced by the power generation module 30, an expected amount of energy 720 used in the system 1, an expected amount of energy 730 used by a specific device calculated through an energy prediction model, an expected amount of energy 740 used by a specific device when a specific device is controlled according to a schedule with the lowest charge based on the amount of energy supplied from the power system 20, and the like.

Referring to FIG. 7, in a period 701 (hereinafter, “peak demand period”) where the charge based on the amount of energy supplied from the power system 20 is high due to peak demand, the expected amount of energy 720 used in the system 1 may be high. In addition, during the peak demand period 701, the expected amount of energy 730 consumed by a specific device may also be high.

At this time, since the charge for power use is high during the peak demand period 701, if a specific device performs a pre-operation to respond to a user demand prior to the peak demand period 701, the power supplied to the specific device from the power system 20 during the peak demand period 701 may be reduced. Here, the pre-operation indicates the operation of a power-using device that meets a certain condition corresponding to user demand during a specific period.

For example, if the power-using device is a heat pump, pre-operation may be performed to raise the temperature of the water stored in the hot water tank to a set temperature for hot water prior to a certain point in time corresponding to the peak demand period 701, according to a schedule that minimizes the charge based on the amount of energy supplied from the power system 20. At this time, as the temperature of the water stored in the hot water tank gradually increases prior to the peak demand period 701 due to pre-operation, the temperature of the water stored in the hot water tank may correspond to the hot water set temperature at a certain point in time corresponding to the peak demand period 701.

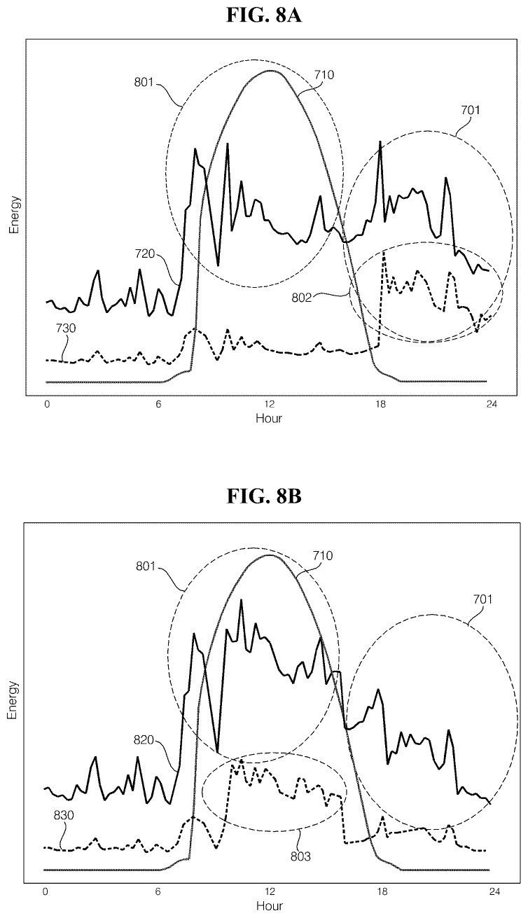

Meanwhile, referring to FIGS. 8A and 8B, there may exist a period 801 in which surplus power is produced in the system 1 prior to the peak demand period 701. For example, if the energy produced in the power generation module 30 exceeds the amount of energy 720 expected to be used in the system 1, and the energy produced in the power generation module 30 remains surplus despite fully charging the battery module 41 of the energy storage system 40, surplus power may be produced in the system 1.

Conventionally, surplus power produced in the system 1 is transmitted to the power system 20 or discarded. However, if a schedule for the operation of component included in the system 1 is determined to utilize the surplus power produced in the system 1, the power supplied to the component included in the system 1 from the power system 20 during the peak demand period 701 may be reduced.

For example, if the power-using device is a washing machine or dryer, even though it is preset to perform an operation to sterilize the interior of the device during the first period 802 corresponding to the peak demand period 701, according to a schedule that minimizes the charge based on the amount of energy supplied from the power system 20, the washing machine or dryer may perform an operation to sterilize the interior of the device during the second period 803 corresponding to the period 801 in which surplus power is produced.

As described above, as a specific device performs pre-operation before the peak demand period 701 when the charge for power use is relatively low, or performs preset operation to avoid the peak demand period 701, it is possible to reduce the charges based on the amount of energy supplied from the power system 20, while satisfying a certain condition corresponding to a user's needs.

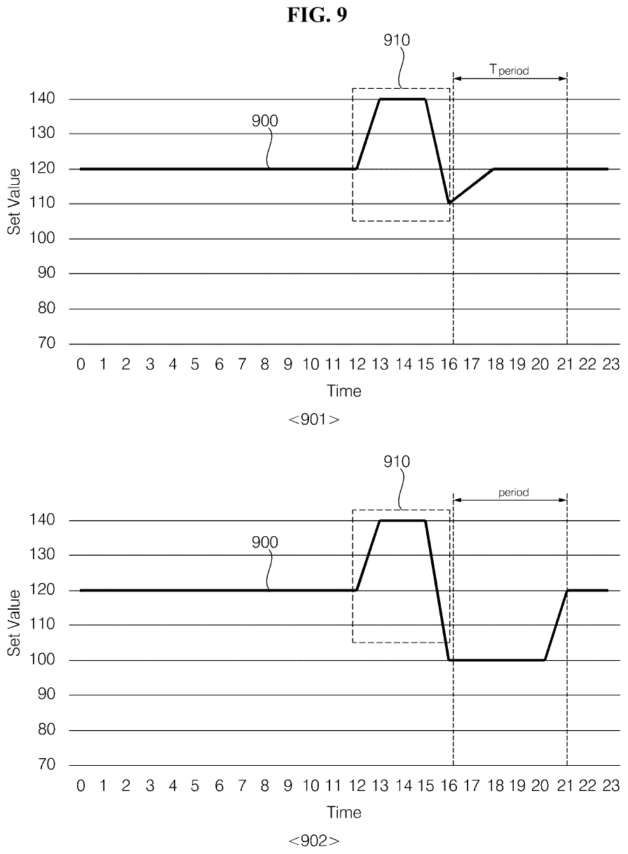

Referring to FIG. 9, the artificial intelligence device 100 may determine a schedule for setting a specific setting value 900 for a specific device (e.g., a heat pump) among power-using devices. At this time, as a specific setting value 900 for a specific device becomes larger, the energy consumed in a specific device may be increased.

The specific setting value 900 for a specific device may be scheduled to increase during a certain period 910. At this time, by increasing the specific setting value 900 for a specific device while avoiding the peak demand period Tperiod, the charges for the amount of energy supplied from the power system 20 may be reduced.

Referring to reference numeral 901, if the amount of energy used by a power-using device during a peak demand period Tperiod is a demand limit value or less, a schedule may be determined such that a specific set value 900 for a specific device is set to a first value.

Meanwhile, referring to reference numeral 902, if the amount of energy used by a power-using device during a peak demand period Tperiod exceeds a demand limit value, a schedule may be determined such that a specific set value 900 for a specific device is set to a second value that is less than the first value.

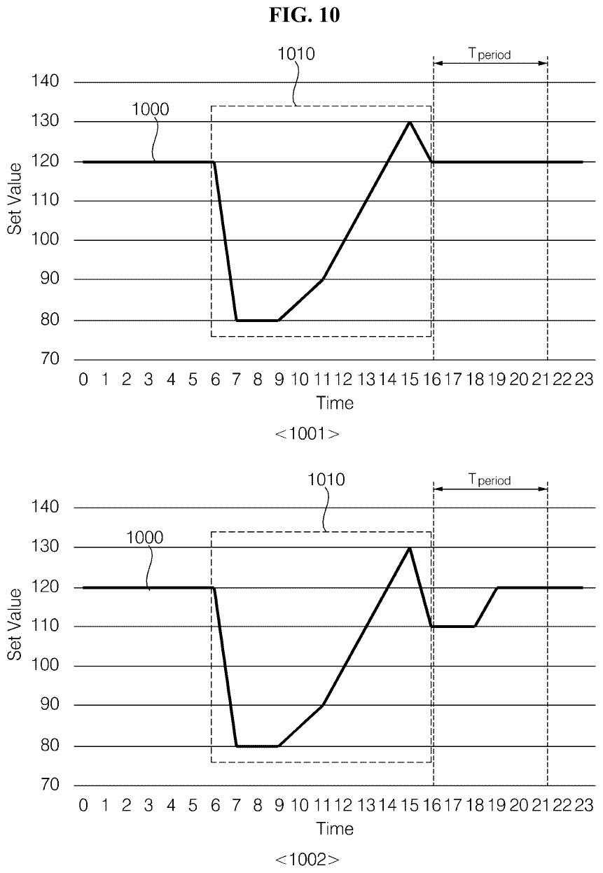

Meanwhile, referring to FIG. 10, the artificial intelligence device 100 may determine a schedule such that a specific device (e.g., a heat pump) among power-using devices performs pre-operation in response to a user request.

If a specific device performs pre-operation, the schedule may be determined such that a specific set value 1000 for a specific device gradually increases from a period 1010 preceding the peak demand period Tperiod. At this time, as the specific set value 1000 for a specific device gradually increases while avoiding the peak demand period Tperiod, the charge based on the amount of energy supplied from the power system 20 may be reduced.

Referring to reference numeral 1001, if the amount of energy used by a power-using device during the peak demand period Tperiod is a demand limit value or less, a schedule may be determined such that the specific set value 1000 for a specific device is set to a first value. Meanwhile, referring to reference numeral 1002, if the amount of energy used by a power-using device during the peak demand period Tperiod exceeds a demand limit value, a schedule may be determined such that the specific set value 1000 for a specific device is set to a third value that is less than the first value.

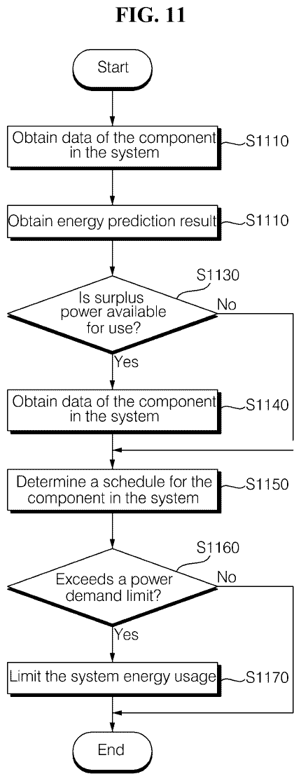

FIG. 11 is a flowchart illustrating an operating method of an artificial intelligence device, according to an embodiment of the present disclosure. Detailed descriptions of content that overlaps with the previously described content will be omitted.

Referring to FIG. 11, the artificial intelligence device 100 may obtain data related to components included in the system 1, at operation S1110.

The artificial intelligence device 100 may obtain an energy prediction result, by using an energy prediction model, at operation S1120.

The artificial intelligence device 100 may determine, based on the energy prediction result, whether the surplus power produced in the system 1 is available for use, at operation S1130. For example, if the energy produced in the power generation module 30 exceeds the amount of energy expected to be used in the system 1, and there exists a period in which the energy produced in the power generation module 30 remains even if the battery module 41 of the energy storage system 40 is fully charged, the artificial intelligence device 100 may determine that the surplus power is available for use.

At operation S1140, if surplus power generated by the system 1 is available for use, the AI device 100 may adjust the load on component included in the system 1. For example, the AI device 100 may adjust the load on component included in the system 1 so that at least one of power-using devices performs an operation corresponding to a user request during a period in which surplus power is available for use.

The power-using device whose load is adjusted to a period in which surplus power is available for use may be preset. For example, the power-using device whose load is adjusted to a period in which surplus power is available for use may be preset based on a user input received through the user input interface 123.

According to an embodiment, the power-using device whose load is adjusted to a period where surplus power is available for use may be preset based on the type of power-using device. For example, the power-using devices whose load is adjusted to a period where surplus power, which is preset based on the type of power-using device, is available for use, may include a washing machine, a dryer, a robot vacuum cleaner, a vehicle charger, and the like. In this case, the heat pump may be excluded from the power-using devices whose loads are adjusted to a period where surplus power is available for use.

At operation S1150, the artificial intelligence device 100 may determine a schedule for the operation of component included in the system 1 based on the energy prediction result. For example, based on Equation 1, the artificial intelligence device 100 may determine a schedule for the operations of the energy storage system 40 to store or release energy to minimize an objective function for charges based on the amount of energy supplied from the power system 20.

For example, based on Equation 2, the artificial intelligence device 100 may determine a schedule for the operation of the energy storage system 40 to store or release energy and a schedule for the operation of the power-using device to minimize an objective function for the charge according to the amount of energy supplied from the power system 20.

According to an embodiment, if the surplus power produced by the system 1 is available for use and the load on the component included in the system 1 is adjusted, the schedule for the operation of the component included in the system 1 may be determined while the load on the component included in the system 1 is adjusted.

At operation S1160, the artificial intelligence device 100 may determine whether the amount of energy used by the power-using device in a specific period, corresponding to the schedule for the operation of the component included in the system 1, exceeds a demand limit value for power.

At operation S1170, if the amount of energy used by a power-using device in a specific period exceeds the demand limit value, the AI device 100 may limit the energy usage of the system 1 in the specific period. For example, the AI device 100 may adjust the schedule for the operation of the power-using device in the specific period so that the amount of energy used by the power-using device in the specific period is equal to or less than the demand limit value.

As described above, according to at least one embodiment of the present disclosure, a schedule for the operation of component included in the system can be determined by predicting the power usage of the component included in the system.

Furthermore, according to at least one embodiment of the present disclosure, a schedule for the operation of component included in the system can be determined by considering the charge for power usage.

Furthermore, according to at least one embodiment of the present disclosure, a schedule for the operation of component included in the system can be determined by considering the request of a customer or power provider.

Referring to FIGS. 1 to 11, an AI device 100 according to an aspect of the present disclosure includes: a memory 170 configured to store a learning model that is learned through a deep learning or machine learning algorithm and predicts an amount of energy corresponding to a component included in a system 1; and a processor 180, wherein the processor 180, by using the learning model, obtains a result predicting an amount of energy corresponding to the component included in the system 1 for a certain period of time, based on data related to the component included in the system 1, determines, based on the result predicting the amount of energy, a schedule for controlling the component included in the system 1 to minimize a charge based on the amount of energy supplied from a power system for the certain period of time, and controls the component included in the system 1 according to the determined schedule.

In addition, according to an aspect of the present disclosure, the processor 180, by using the learning model, obtains a first result predicting an amount of energy stored in the system 1, a second result predicting an amount of energy produced by the system 1, and a third result predicting an amount of energy used by the system 1, and determine, based on the first result, the second result, and the third result, a schedule for controlling a charging and discharging of an energy storage system included in the system 1 to minimize the charge.

In addition, according to an aspect of the present disclosure, the processor 180, by using the learning model, obtains a first result predicting an amount of energy stored in the system 1, a second result predicting an amount of energy produced by the system 1, and a third result predicting an amount of energy used by a power-using device included in the system 1, and determine, based on the first result, the second result, and the third result, a first schedule for controlling a charging and discharging of an energy storage system included in the system 1 and a second schedule for controlling at least one of a mode and a setting value of the power-using device to minimize the charge.

In addition, according to an aspect of the present disclosure, the power-using device is a heat pump including a compressor, and the second schedule includes a sequence for an operating frequency of the compressor.

In addition, according to an aspect of the present disclosure, the processor 180 determines whether the third result in a specific period exceeds a maximum value when the maximum value of an amount of energy permitted for use by the power-using device in the specific period for the certain period of time is preset, determines the second schedule, based on whether the third result in the specific period is the maximum value or less, and determines a third schedule which controls at least one of the mode and the setting value of the power-using device, based on whether the third result in the specific period exceeds the maximum value, wherein the third schedule limits the amount of energy used by the power-using device in the specific period to the maximum value or less.

In addition, according to an aspect of the present disclosure, when there exist two or more power-using devices, the processor 180 determines the third schedule, based on priorities among the two or more power-using devices, and when a priority of a first power-using device is higher than that of a second power-using device, in the specific period, a first reduction value corresponding to a difference between a first amount of energy used by the first power-using device corresponding to the second schedule and a second amount of energy used by the first power-using device corresponding to the third schedule is smaller than a second reduction value corresponding to a difference between a third amount of energy used by the second power-using device corresponding to the second schedule and a fourth amount of energy used by the second power-using device corresponding to the third schedule.

In addition, according to an aspect of the present disclosure, the artificial intelligence device further includes a user input interface 123; and an output interface 150, wherein the processor 180 outputs, through the output interface 150, a notification for a limitation on the amount of energy used by the power-using device in the specific period, based on the third result in the specific period exceeding the maximum value, and determines the third schedule, on the basis that a user input corresponding to adjustment of schedule through the user input interface 123 is received.

In addition, according to an aspect of the present disclosure, the processor 180 outputs, through the output interface 150, information corresponding to the third schedule, on the basis that the third result in the specific period exceeds the maximum value.

In addition, according to an aspect of the present disclosure, the processor 180 determines, based on the first result, the second result, and the third result, whether surplus power generated by the system 1 is available for use, and, based on the surplus power being available for use, adjusts a load on the power-using device, in response to a certain period in which the surplus power is available for use, and determines the first schedule and the second schedule, while the load on the power-using device is adjusted.

In addition, according to an aspect of the present disclosure, the learning model includes a transLSTM model that combines a transformer model and a Long Short-Term Memory (LSTM) model.

A method of operating an artificial intelligence device 100 according to an aspect of the present disclosure includes: an amount of energy prediction operation for obtaining, by using a learning model that is learned through a deep learning or machine learning algorithm and predicts an amount of energy corresponding to a component included in a system 1, a result predicting an amount of energy corresponding to the component included in the system 1 for a certain period of time, based on data related to the component included in the system 1; a schedule determination operation for determining, based on the result predicting the amount of energy, a schedule for controlling the component included in the system 1 to minimize a charge based on the amount of energy supplied from a power system for the certain period of time; and a control operation for controlling the component included in the system 1 according to the determined schedule.

In addition, according to an aspect of the present disclosure, the amount of energy prediction operation includes an operation of obtaining, by using the learning model, a first result predicting an amount of energy stored in the system 1, a second result predicting an amount of energy produced by the system 1, and a third result predicting an amount of energy used by the system 1, and wherein the schedule determination operation includes an operation of determining a schedule for controlling a charging and discharging of an energy storage system included in the system 1 to minimize the charge, based on the first result, the second result, and the third result.

In addition, according to an aspect of the present disclosure, the amount of energy prediction operation includes an operation of obtaining, by using the learning model, a first result predicting an amount of energy stored in the system 1, a second result predicting an amount of energy produced by the system 1, and a third result predicting an amount of energy used by a power-using device included in the system 1, and wherein the schedule determination operation includes an operation of determining a first schedule for controlling a charging and discharging of an energy storage system included in the system 1 and a second schedule for controlling at least one of a mode and a setting value of the power-using device to minimize the charge, based on the first result, the second result, and the third result.

In addition, according to an aspect of the present disclosure, the power-using device is a heat pump comprising a compressor, and the second schedule includes a sequence for an operating frequency of the compressor.

In addition, according to an aspect of the present disclosure, the schedule determination operation includes: an operation of determining whether the third result in a specific period exceeds a maximum value when the maximum value of an amount of energy permitted for use by the power-using device in the specific period for the certain period of time is preset; an operation of determining the second schedule, based on whether the third result in the specific period is the maximum value or less; and an operation of determining a third schedule which controls at least one of the mode and the setting value of the power-using device, based on whether the third result in the specific period exceeds the maximum value, wherein the third schedule limits the amount of energy used by the power-using device in the specific period to the maximum value or less.

In addition, according to an aspect of the present disclosure, the operation of determining a third schedule includes an operation of, when there exist two or more power-using devices, determining the third schedule, based on priorities among the two or more power-using devices, and wherein when a priority of a first power-using device is higher than that of a second power-using device, in the specific period, a first reduction value corresponding to a difference between a first amount of energy used by the first power-using device corresponding to the second schedule and a second amount of energy used by the first power-using device corresponding to the third schedule is smaller than a second reduction value corresponding to a difference between a third amount of energy used by the second power-using device corresponding to the second schedule and a fourth amount of energy used by the second power-using device corresponding to the third schedule.

In addition, according to an aspect of the present disclosure, the schedule determination operation includes: an operation of outputting a notification for a limitation on the amount of energy used by the power-using device in the specific period, based on the third result in the specific period exceeding the maximum value; and an operation of determining the third schedule, on the basis that a user input corresponding to adjustment of schedule is received.

In addition, according to an aspect of the present disclosure, the schedule determination operation includes an operation of outputting information corresponding to the third schedule, on the basis that the third result in the specific period exceeds the maximum value.

In addition, according to an aspect of the present disclosure, the schedule determination operation includes: an operation of determining, based on the first result, the second result, and the third result, whether surplus power generated by the system 1 is available for use; an operation of, based on the surplus power being available for use, adjusting a load on the power-using device, in response to a certain period in which the surplus power is available for use; and an operation of determining the first schedule and the second schedule, while the load on the power-using device is adjusted.

In addition, according to an aspect of the present disclosure, the learning model includes a transLSTM model that combines a transformer model and an LSTM (Long Short-Term Memory) model.

As described above, according to various embodiments of the present disclosure, the schedule for the operation of component included in the system can be determined, by predicting the power usage of the component included in the system.

Furthermore, according to various embodiments of the present disclosure, the schedule for the operation of component included in the system can be determined, by considering the charges for power usage.

Furthermore, according to various embodiments of the present disclosure, the schedule for the operation of component included in the system can be determined, by considering requests from customers or power providers.

What is claimed is:

1. An artificial intelligence device comprising:
a memory configured to store a learning model that is learned through a deep learning or machine learning algorithm and predicts an amount of energy corresponding to a component included in a system; and
a processor configured to:
by using the learning model, obtain a result predicting an amount of energy corresponding to the component included in the system for a certain period of time, based on data related to the component included in the system,
determine, based on the result predicting the amount of energy, a schedule for controlling the component included in the system to minimize a charge based on the amount of energy supplied from a power system for the certain period of time, and
control the component included in the system according to the determined schedule.

2. The artificial intelligence device of claim 1, wherein the processor is configured to:
by using the learning model, obtain a first result predicting an amount of energy stored in the system, a second result predicting an amount of energy produced by the system, and a third result predicting an amount of energy used by the system, and
determine, based on the first result, the second result, and the third result, a schedule for controlling a charging and discharging of an energy storage system included in the system to minimize the charge.

3. The artificial intelligence device of claim 1, wherein the processor is configured to:
by using the learning model, obtain a first result predicting an amount of energy stored in the system, a second result predicting an amount of energy produced by the system, and a third result predicting an amount of energy used by a power-using device included in the system, and
determine, based on the first result, the second result, and the third result, a first schedule for controlling a charging and discharging of an energy storage system included in the system and a second schedule for controlling at least one of a mode and a setting value of the power-using device to minimize the charge.

4. The artificial intelligence device of claim 3, wherein the power-using device is a heat pump comprising a compressor, and
the second schedule comprises a sequence for an operating frequency of the compressor.

5. The artificial intelligence device of claim 3, wherein the processor is configured to:
determine whether the third result in a specific period exceeds a maximum value when the maximum value of an amount of energy permitted for use by the power-using device in the specific period for the certain period of time is preset,
determine the second schedule, based on whether the third result in the specific period is the maximum value or less, and
determine a third schedule which controls at least one of the mode and the setting value of the power-using device, based on whether the third result in the specific period exceeds the maximum value, wherein the third schedule limits the amount of energy used by the power-using device in the specific period to the maximum value or less.

6. The artificial intelligence device of claim 5, wherein, when there exist two or more power-using devices, the processor is configured to determine the third schedule based on priorities among the two or more power-using devices, and
when a priority of a first power-using device is higher than that of a second power-using device, in the specific period, a first reduction value corresponding to a difference between a first amount of energy used by the first power-using device corresponding to the second schedule and a second amount of energy used by the first power-using device corresponding to the third schedule is smaller than a second reduction value corresponding to a difference between a third amount of energy used by the second power-using device corresponding to the second schedule and a fourth amount of energy used by the second power-using device corresponding to the third schedule.

7. The artificial intelligence device of claim 5, further comprising:
a user input interface; and
an output interface,
wherein the processor is configured to:
output, through the output interface, a notification for a limitation on the amount of energy used by the power-using device in the specific period, based on the third result in the specific period exceeding the maximum value, and
determine the third schedule, on the basis that a user input corresponding to adjustment of schedule through the user input interface is received.

8. The artificial intelligence device of claim 7, wherein the processor is configured to output, through the output interface, information corresponding to the third schedule, on the basis that the third result in the specific period exceeds the maximum value.

9. The artificial intelligence device of claim 3, wherein the processor is configured to:
determine, based on the first result, the second result, and the third result, whether surplus power generated by the system is available for use, and,
based on the surplus power being available for use, adjust a load on the power-using device, in response to a certain period in which the surplus power is available for use, and,
determine the first schedule and the second schedule, while the load on the power-using device is adjusted.

10. The artificial intelligence device of claim 1, wherein the learning model comprises a transLSTM model that combines a transformer model and a Long Short-Term Memory (LSTM) model.

11. A method of operating an artificial intelligence device, the method comprising:
an amount of energy prediction operation for obtaining, by using a learning model that is learned through a deep learning or machine learning algorithm and predicts an amount of energy corresponding to a component included in a system, a result predicting an amount of energy corresponding to the component included in the system for a certain period of time, based on data related to the component included in the system;
a schedule determination operation for determining, based on the result predicting the amount of energy, a schedule for controlling the component included in the system to minimize a charge based on the amount of energy supplied from a power system for the certain period of time; and
a control operation for controlling the component included in the system according to the determined schedule.

12. The method of claim 11, wherein the amount of energy prediction operation comprises an operation of obtaining, by using the learning model, a first result predicting an amount of energy stored in the system, a second result predicting an amount of energy produced by the system, and a third result predicting an amount of energy used by the system, and
wherein the schedule determination operation comprises an operation of determining a schedule for controlling a charging and discharging of an energy storage system included in the system to minimize a charge, based on the first result, the second result, and the third result.

13. The method of claim 11, wherein the amount of energy prediction operation comprises an operation of obtaining, by using the learning model, a first result predicting an amount of energy stored in the system, a second result predicting an amount of energy produced by the system, and a third result predicting an amount of energy used by a power-using device included in the system, and
wherein the schedule determination operation comprises an operation of determining a first schedule for controlling a charging and discharging of an energy storage system included in the system and a second schedule for controlling at least one of a mode and a setting value of the power-using device to minimize the charge, based on the first result, the second result, and the third result.

14. The method of claim 13, wherein the power-using device is a heat pump comprising a compressor, and
the second schedule comprises a sequence for an operating frequency of the compressor.

15. The method of claim 13, wherein the schedule determination operation comprises:
an operation of determining whether the third result in a specific period exceeds a maximum value when the maximum value of an amount of energy permitted for use by the power-using device in the specific period for the certain period of time is preset;
an operation of determining the second schedule, based on whether the third result in the specific period is the maximum value or less; and
an operation of determining a third schedule which controls at least one of the mode and the setting value of the power-using device, based on whether the third result in the specific period exceeds the maximum value, wherein the third schedule limits the amount of energy used by the power-using device in the specific period to the maximum value or less.

16. The method of claim 15, wherein the operation of determining a third schedule comprises an operation of, when there exist two or more power-using devices, determining the third schedule, based on priorities among the two or more power-using devices, and
wherein when a priority of a first power-using device is higher than that of a second power-using device, in the specific period, a first reduction value corresponding to a difference between a first amount of energy used by the first power-using device corresponding to the second schedule and a second amount of energy used by the first power-using device corresponding to the third schedule is smaller than a second reduction value corresponding to a difference between a third amount of energy used by the second power-using device corresponding to the second schedule and a fourth amount of energy used by the second power-using device corresponding to the third schedule.

17. The method of claim 15, wherein the schedule determination operation comprises:
an operation of outputting a notification for a limitation on the amount of energy used by the power-using device in the specific period, based on the third result in the specific period exceeding the maximum value; and
an operation of determining the third schedule, on the basis that a user input corresponding to adjustment of schedule is received.

18. The method of claim 17, wherein the schedule determination operation comprises an operation of outputting information corresponding to the third schedule, on the basis that the third result in the specific period exceeds the maximum value.

19. The method of claim 13, wherein the schedule determination operation comprises:
an operation of determining, based on the first result, the second result, and the third result, whether surplus power generated by the system is available for use;
an operation of, based on the surplus power being available for use, adjusting a load on the power-using device, in response to a certain period in which the surplus power is available for use; and
an operation of determining the first schedule and the second schedule, while the load on the power-using device is adjusted.

20. The method of claim 11, wherein the learning model comprises a transLSTM model that combines a transformer model and an LSTM (Long Short-Term Memory) model.
